(19) United States
(12) Patent Application Publication
(10) Pub. No.: US 2024/0399800 A1
(43) Pub. Date: Dec. 5, 2024

(54) Continuous Tire Inflation System Implementation

(71) Applicant: CNH Industrial America LLC, New Holland, PA (US)

(72) Inventors: Michael Jensen, New Holland, PA (US); Sukhmeet Singh, New Holland, PA (US); Adam Abernethy, New Holland, PA (US)

(73) Assignee: CNH Industrial America LLC, New Holland, PA (US)

(21) Appl. No.: 18/329,351

(22) Filed: Jun. 5, 2023

(51) Int. Cl. B60C 23/00

(52) U.S. Cl. CPC B60C 23/00336; B60C 23/00363; B60C 2200/08

(57) ABSTRACT

A continuous tire inflation system (CTIS) including a first outer O-ring, a second outer O-ring, a CTIS adopter in fluid communication to a trumpet housing, where the first outer O-ring and the second outer O-ring cause a seal between an outer surface of the CTIS adopter and the inner surface of the trumpet housing. The system including a first sealing bush adopter, a second sealing bush adopter, a first CTIS seal, a second CTIS seal, a first retaining ring configured to retain the first CTIS seal in physical contact with the CTIS adopter; a second retaining ring configured to retain the second CTIS seal in physical contact with the CTIS adopter.

### BACKGROUND

Certain vehicles, such as tractors, need to be able to inflate and deflate tires during operation. One of the main reasons is that different types of terrain require different levels of tire pressure to optimize performance. For example, when working on soft soil or in marshy conditions, deflating the tires increases the surface area in contact with the ground, providing better traction and reducing compaction. On the other hand, when operating on hard surfaces, such as roads or concrete, inflating the tires to the recommended pressure reduces rolling resistance, which increases fuel efficiency and prolongs tire life. Additionally, inflating or deflating tires can be a way to adjust the height of the tractor, which may be important when working with implements that require a specific ground clearance.

Traditional methods of inflating the tires of a tractor are time consuming and inefficient. The most common method is to use an air compressor or a portable air pump with a gauge to inflate or deflate the tires. The operator uses the gauge to check the pressure and adjust it to the recommended level. To deflate the tires, the operator can use a valve stem tool or a similar device to remove the valve core and release the air.

While some tractors have onboard air compressors to inflate and deflate the tires, the systems are usually external to the wheels and subject to damage.

### SUMMARY

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general implementation, an agricultural vehicle may include a chassis. The agricultural vehicle may also include a trumpet housing fixedly coupled to the chassis, the trumpet housing having an intake channel from an outer surface of the trumpet housing to an inner surface of the trumpet housing. The agricultural vehicle may furthermore include an air compressor in fluid communication with the intake channel of the trumpet housing at the outer surface of the trumpet housing. The agricultural vehicle may in addition include an axle rotatably coupled to the trumpet housing by at least one roller bearing so as to allow the axle to rotate about a longitudinal axis of the axle, where the axle has a bored center channel along the longitudinal axis of the axle, the axle further having a supply channel through a diameter of the axle proximate an inner end of the axle, the inner end having a splined profile to cooperatively couple to an epicyclic reduction housing. The agricultural vehicle may moreover include an continuous tire inflation system (CTIS) having: a first outer O-ring; a second outer O-ring; a CTIS adopter in fluid communication to the trumpet housing, where the first outer O-ring and the second outer O-ring cause a seal between an outer surface of the CTIS adopter and the inner surface of the trumpet housing; a first sealing bush adopter, where an inner surface of the first sealing bush adopter interfaces with an outer surface of the axle; a second sealing bush adopter, where an inner surface of the second sealing bush adopter interfaces with the outer surface of the axle; a first CTIS seal configured to interface between an inner surface of the CTIS adopter and an outer surface of the first sealing bush adopter; a second CTIS seal configured to interface between the inner surface of the CTIS adopter and an outer surface of the second sealing bush adopter; a first retaining ring configured to retain the first CTIS seal in physical contact with the CTIS adopter; a second retaining ring configured to retain the second CTIS seal in physical contact with the CTIS adopter. The agricultural vehicle may also include at least one inflatable tire fixedly coupled to the axle and in fluid communication with the bored center channel of the axle. Other embodiments of this aspect include corresponding computer systems, apparatus, and computer programs recorded on one or more computer storage devices, each configured to perform the actions of the methods.

Implementations may include one or more of the following features. The agricultural vehicle where the agricultural vehicle is a tractor. The agricultural vehicle where the at least on inflatable tire is in fluid communication to the bored center channel of the axle by a flexible pipe. The agricultural vehicle where the bored center channel of the axle is closed at the inner end. The agricultural vehicle where the axle is a rear-drive axle of the agricultural vehicle. The agricultural vehicle where the CTIS is in fluid communication with the intake channel at the inner surface of the trumpet housing, where the CTIS is in further fluid communication with the supply channel of the axle. The agricultural vehicle where the first sealing bush adopter and the second sealing bush adopter interlock on either side of the supply channel through the diameter of the axle to seal a fluid passage between the intake channel and the supply channel. The agricultural vehicle where the agricultural vehicle is configured to function both with and without the CTIS. Implementations of the described techniques may include hardware, a method or process, or a computer tangible medium.

In one general aspect, the continuous tire inflation system may include a first outer O-ring. The continuous tire inflation system may also include a second outer O-ring. System may furthermore include a CTIS adopter in fluid communication with a trumpet housing, where the first outer O-ring and the second outer O-ring cause a seal between an outer surface of the CTIS adopter and an inner surface of the trumpet housing. The CTIS may in addition include a first sealing bush adopter, where an inner surface of the first sealing bush adopter interfaces with an outer surface of an axle. The CTIS may moreover include a second sealing bush adopter, where an inner surface of the second sealing bush adopter interfaces with the outer surface of the axle. The CTIS may also include a first CTIS seal configured to interface between an inner surface of the CTIS adopter and an outer surface of the first sealing bush adopter. The CTIS may furthermore include a second CTIS seal configured to interface between the inner surface of the CTIS adopter and an outer surface of the second sealing bush adopter. The CTIS may in addition include a first retaining ring configured to retain the first CTIS seal in physical contact with the CTIS adopter. The CTIS may moreover include a second retaining ring configured to retain the second CTIS seal in physical contact with the CTIS adopter. Other embodiments of this aspect include corresponding computer systems, apparatus, and computer programs recorded on one or more computer storage devices, each configured to perform the actions of the methods.

Implementations may include one or more of the following features. The CTIS where the first sealing bush adopter and the second sealing bush adopter interlock on either side of a supply channel through a diameter of the axle to seal a fluid passage between an air intake of the trumpet housing and the supply channel. The CTIS where the CTIS is configured to seal a path of fluid between the trumpet housing and an inflatable tire. The CTIS where the CTIS is configured to allow fluid to flow into an inflatable tire and out of the inflatable tire. The CTIS where the CTIS adopter having a first O-ring groove to receive the first outer O-ring, the CTIS adopter further having a second O-ring groove to receive the second outer O-ring. The CTIS where the CTIS is installed on an agricultural vehicle. The CTIS where the CTIS is an aftermarket add-on. The CTIS where the CTIS is installed internally on the trumpet housing. Implementations of the described techniques may include hardware, a method or process, or a computer tangible medium.

In one general aspect, a method may include installing a tapered roller bearing into an inner surface of a trumpet housing. The method may also include installing a rear axle shaft subassembly through an inner surface of the tapered roller bearing. The method may furthermore include installing a first O-ring into a first axle groove and second O-ring into a second axle groove. The method may in addition include installing a first sealing bush adopter onto the rear axle shaft, the first sealing bush adopter placed over the first O-ring. The method may moreover include installing a CTIS subassembly, the CTIS subassembly having a CTIS adopter, a first CTIS seal, a second CTIS seal, a first outer O-ring, a second outer O-ring, a first retaining clip, and a second retaining clip. The method may also include installing an internal snap ring to secure the CTIS subassembly. The method may furthermore include installing a second sealing bush adopter onto the rear axle shaft, the second sealing bush adopter placed over the second O-ring. The method may in addition include installing an epicyclic reduction housing onto an inner end of the rear axle shaft. Other embodiments of this aspect include corresponding computer systems, apparatus, and computer programs recorded on one or more computer storage devices, each configured to perform the actions of the methods.

Implementations may include one or more of the following features. The CTIS may include preloading the tapered roller bearing. The CTIS may include attaching an air compressor to an intake channel in the trumpet housing, the intake channel in fluid communication with the CTIS adopter. The CTIS where the CTIS is installed on an agricultural vehicle. Implementations of the described techniques may include hardware, a method or process, or a computer tangible medium

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a driveline of the vehicle of FIG. 1, according to an exemplary embodiment.

FIG. 4 is a cross-sectional view of a continuous tire inflation system, according to an exemplary embodiment.

FIG. 5 is a is a cross-sectional view of a CTIS subassembly, according to an exemplary embodiment.

FIG. 6 is an isometric cross-sectional view of the CTIS, according to an exemplary embodiment.

FIG. 7 is a is a cross-sectional view of a trumpet housing, according to an exemplary embodiment.

FIG. 8 is an isometric view of the trumpet housing, according to an exemplary embodiment.

FIG. 9 is a cross-sectional view of an axle, according to an exemplary embodiment.

FIG. 10 is a cross-sectional view of the axle, according to an exemplary embodiment.

FIG. 11 is a cross-sectional view of an exemplary lip seal, according to an exemplary embodiment.

FIG. 12 is an isometric, cross-sectional view of a CTIS, according to an exemplary embodiment.

FIG. 13 is an exploded view of a portion of the CTIS subassembly, according to an exemplary embodiment.

FIG. 14 is a cross-sectional view of a portion of the CTIS subassembly, according to an exemplary embodiment.

FIG. 15 is an isometric view of the trumpet housing and axle, according to an exemplary embodiment.

FIG. 16 is a cross-sectional view of the axle in the trumpet housing, according to an exemplary embodiment.

FIG. 17 is an exploded view of the CTIS subassembly, the trumpet housing, and the axle, according to an exemplary embodiment.

FIG. 18 is a cross-sectional view of the CTIS installed in the trumpet housing, according to an exemplary embodiment.

FIG. 19 is a cross-sectional view of the trumpet housing, according to an exemplary embodiment.

FIG. 20 is a cross-sectional view of the CTIS, according to an exemplary embodiment.

FIG. 21 is a cross-sectional view of the CTIS subassembly, according to an exemplary embodiment.

FIG. 22 is an isometric, cross-sectional view of the CTIS, according to an exemplary embodiment.

FIG. 23 is a cross-sectional view of the trumpet housing, according to an exemplary embodiment.

FIG. 24 is an isometric view of the trumpet housing, according to an exemplary embodiment.

FIG. 25 is a cross-sectional view of the axle, according to an exemplary embodiment.

FIG. 26 is a cross-sectional view of the axle, according to an exemplary embodiment.

FIG. 27 is an isometric, a cross-sectional view of the CTIS subassembly, according to an exemplary embodiment.

FIG. 28 is an isometric view of the axle, according to an exemplary embodiment.

FIG. 29 is an isometric view of the axle, according to an exemplary embodiment.

FIG. 30 is an isometric, exploded view of the CTIS, according to an exemplary embodiment.

FIG. 31 is a cross-sectional view of the CTIS subassembly, according to an exemplary embodiment.

FIG. 32 is an exploded, isometric view of a bearing system, according to an exemplary embodiment.

FIG. 33 is a flow diagram of a process for installing the CTIS, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a continuous tire inflation system (“CTIS”) of the present disclosure includes an axle, a trumpet housing, and a CTIS subassembly. Various components of the present disclosure may be installed on any vehicle, including agricultural vehicles (e.g., a tractor) on the interior of the wheel (in one embodiment, the interior of the trumpet housing) so as to protect the CTIS from damage when operating the vehicle. The trumpet housing may have an air intake channel through it to couple to the CTIS subassembly in the hub of the trumpet housing in fluid communication. The CTIS subassembly surrounds the axle and seals the air intake from the trumpet housing to the axle. In some embodiments, the axle has cross bores in it to allow for a fluid (e.g., air) to pass into the axle. The axle may also have an air delivery channel bored along a longitudinal axis of the axle. The air delivery channel may be in fluid communication with the cross bores so as to allow a fluid to travel from the air intake to the air delivery channel. The air delivery channel is coupled with a flexible hose in fluid communication with an inflatable tire.

### Overall Vehicle

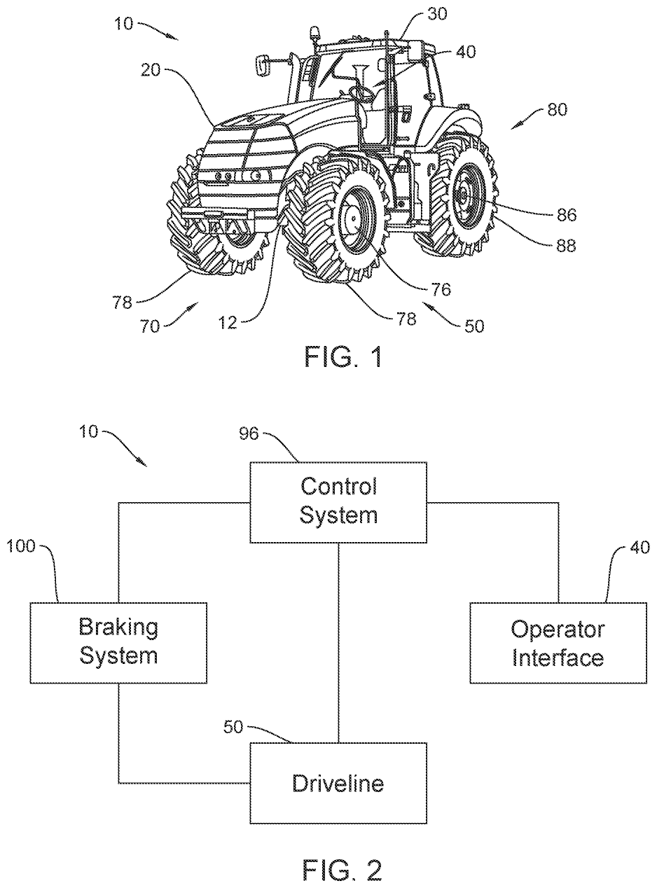

According to the exemplary embodiment shown in FIGS. 1-3, a machine or vehicle, shown as vehicle 10, includes a chassis, shown as frame 12; a body assembly, shown as body 20, coupled to the frame 12 and having an occupant portion or section, shown as cab 30; operator input and output devices, shown as operator interface 40, that are disposed within the cab 30; a drivetrain, shown as driveline 50, coupled to the frame 12 and at least partially disposed under the body 20; a vehicle braking system, shown as braking system 92, coupled to one or more components of the driveline 50 to facilitate selectively braking the one or more components of the driveline 50; and a vehicle control system, shown as control system 200, coupled to the operator interface 40, the driveline 50, and the braking system 100. In other embodiments, the vehicle 10 includes more or fewer components.

The chassis of the vehicle 10 may include a structural frame (e.g., the frame 12) formed from one or more frame members coupled to one another (e.g., as a weldment). Additionally or alternatively, the chassis may include a portion of the driveline 50. By way of example, a component of the driveline 50 (e.g., the transmission 52) may include a housing of sufficient thickness to provide the component with strength to support other components of the vehicle 10.

According to an exemplary embodiment, the vehicle 10 is an off-road machine or vehicle. In some embodiments, the off-road machine or vehicle is an agricultural machine or vehicle such as a tractor, a telehandler, a front loader, a combine harvester, a grape harvester, a forage harvester, a sprayer vehicle, a speedrower, and/or another type of agricultural machine or vehicle. In some embodiments, the off-road machine or vehicle is a construction machine or vehicle such as a skid steer loader, an excavator, a backhoe loader, a wheel loader, a bulldozer, a telehandler, a motor grader, and/or another type of construction machine or vehicle. In some embodiments, the vehicle 10 includes one or more attached implements and/or trailed implements such as a front mounted mower, a rear mounted mower, a trailed mower, a tedder, a rake, a baler, a plough, a cultivator, a rotavator, a tiller, a harvester, and/or another type of attached implement or trailed implement.

According to an exemplary embodiment, the cab 30 is configured to provide seating for an operator (e.g., a driver, etc.) of the vehicle 10. In some embodiments, the cab 30 is configured to provide seating for one or more passengers of the vehicle 10. According to an exemplary embodiment, the operator interface 40 is configured to provide an operator with the ability to control one or more functions of and/or provide commands to the vehicle 10 and the components thereof (e.g., turn on, turn off, drive, turn, brake, engage various operating modes, raise/lower an implement, etc.). The operator interface 40 may include one or more displays and one or more input devices. The one or more displays may be or include a touchscreen, a LCD display, a LED display, a speedometer, gauges, warning lights, etc. The one or more input device may be or include a steering wheel, a joystick, buttons, switches, knobs, levers, an accelerator pedal, a brake pedal, etc.

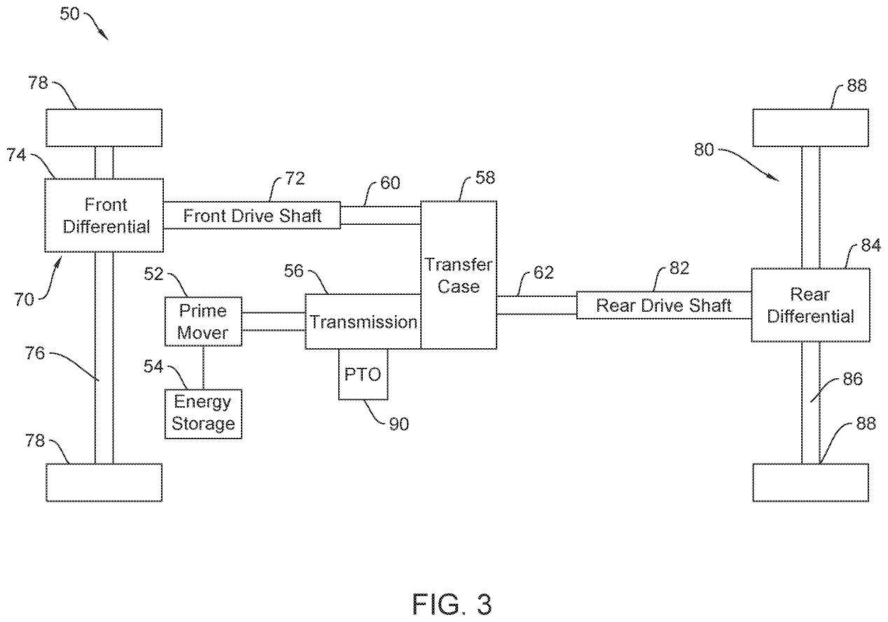

According to an exemplary embodiment, the driveline 50 is configured to propel the vehicle 10. As shown in FIG. 3, the driveline 50 includes a primary driver, shown as prime mover 52, and an energy storage device, shown as energy storage 54. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system.

As shown in FIG. 3, the driveline 50 includes a transmission device (e.g., a gearbox, a continuous variable transmission (“CVT”), etc.), shown as transmission 56, coupled to the prime mover 52; a power divider, shown as transfer case 58, coupled to the transmission 56; a first tractive assembly, shown as front tractive assembly 70, coupled to a first output of the transfer case 58, shown as front output 60; and a second tractive assembly, shown as rear tractive assembly 80, coupled to a second output of the transfer case 58, shown as rear output 62. According to an exemplary embodiment, the transmission 56 has a variety of configurations (e.g., gear ratios, etc.) and provides different output speeds relative to a mechanical input received thereby from the prime mover 52. In some embodiments (e.g., in electric driveline configurations, in hybrid driveline configurations, etc.), the driveline 50 does not include the transmission 56. In such embodiments, the prime mover 52 may be directly coupled to the transfer case 58. According to an exemplary embodiment, the transfer case 58 is configured to facilitate driving both the front tractive assembly 70 and the rear tractive assembly 80 with the prime mover 52 to facilitate front and rear drive (e.g., an all-wheel-drive vehicle, a four-wheel-drive vehicle, etc.). In some embodiments, the transfer case 58 facilitates selectively engaging rear drive only, front drive only, and both front and rear drive simultaneously. In some embodiments, the transmission 56 and/or the transfer case 58 facilitate selectively disengaging the front tractive assembly 70 and the rear tractive assembly 80 from the prime mover 52 (e.g., to permit free movement of the front tractive assembly 70 and the rear tractive assembly 80 in a neutral mode of operation). In some embodiments, the driveline 50 does not include the transfer case 58. In such embodiments, the prime mover 52 or the transmission 56 may directly drive the front tractive assembly 70 (i.e., a front-wheel-drive vehicle) or the rear tractive assembly 80 (i.e., a rear-wheel-drive vehicle).

As shown in FIGS. 1 and 3, the front tractive assembly 70 includes a first drive shaft, shown as front drive shaft 72, coupled to the front output 60 of the transfer case 58; a first differential, shown as front differential 74, coupled to the front drive shaft 72; a first axle, shown front axle 76, coupled to the front differential 74; and a first pair of tractive elements, shown as front tractive elements 78, coupled to the front axle 76. In some embodiments, the front tractive assembly 70 includes a plurality of front axles 76. In some embodiments, the front tractive assembly 70 does not include the front drive shaft 72 or the front differential 74 (e.g., a rear-wheel-drive vehicle). In some embodiments, the front drive shaft 72 is directly coupled to the transmission 56 (e.g., in a front-wheel-drive vehicle, in embodiments where the driveline 50 does not include the transfer case 58, etc.) or the prime mover 52 (e.g., in a front-wheel-drive vehicle, in embodiments where the driveline 50 does not include the transfer case 58 or the transmission 56, etc.). The front axle 76 may include one or more components.

As shown in FIGS. 1 and 3, the rear tractive assembly 80 includes a second drive shaft, shown as rear drive shaft 82, coupled to the rear output 62 of the transfer case 58; a second differential, shown as rear differential 84, coupled to the rear drive shaft 82; a second axle, shown rear axle 86, coupled to the rear differential 84; and a second pair of tractive elements, shown as rear tractive elements 88, coupled to the rear axle 86. In some embodiments, the rear tractive assembly 80 includes a plurality of rear axles 86. In some embodiments, the rear tractive assembly 80 does not include the rear drive shaft 82 or the rear differential 84 (e.g., a front-wheel-drive vehicle). In some embodiments, the rear drive shaft 82 is directly coupled to the transmission 56 (e.g., in a rear-wheel-drive vehicle, in embodiments where the driveline 50 does not include the transfer case 58, etc.) or the prime mover 52 (e.g., in a rear-wheel-drive vehicle, in embodiments where the driveline 50 does not include the transfer case 58 or the transmission 56, etc.). The rear axle 86 may include one or more components. According to the exemplary embodiment shown in FIG. 1, the front tractive elements 78 and the rear tractive elements 88 are structured as wheels. In other embodiments, the front tractive elements 78 and the rear tractive elements 88 are otherwise structured (e.g., tracks, etc.). In some embodiments, the front tractive elements 78 and the rear tractive elements 88 are both steerable. In other embodiments, only one of the front tractive elements 78 or the rear tractive elements 88 is steerable. In still other embodiments, both the front tractive elements 78 and the rear tractive elements 88 are fixed and not steerable.

In some embodiments, the driveline 50 includes a plurality of prime movers 52. By way of example, the driveline 50 may include a first prime mover 52 that drives the front tractive assembly 70 and a second prime mover 52 that drives the rear tractive assembly 80. By way of another example, the driveline 50 may include a first prime mover 52 that drives a first one of the front tractive elements 78, a second prime mover 52 that drives a second one of the front tractive elements 78, a third prime mover 52 that drives a first one of the rear tractive elements 88, and/or a fourth prime mover 52 that drives a second one of the rear tractive elements 88. By way of still another example, the driveline 50 may include a first prime mover that drives the front tractive assembly 70, a second prime mover 52 that drives a first one of the rear tractive elements 88, and a third prime mover 52 that drives a second one of the rear tractive elements 88. By way of yet another example, the driveline 50 may include a first prime mover that drives the rear tractive assembly 80, a second prime mover 52 that drives a first one of the front tractive elements 78, and a third prime mover 52 that drives a second one of the front tractive elements 78. In such embodiments, the driveline 50 may not include the transmission 56 or the transfer case 58.

As shown in FIG. 3, the driveline 50 includes a power-take-off (“PTO”), shown as PTO 90. While the PTO 90 is shown as being an output of the transmission 56, in other embodiments the PTO 90 may be an output of the prime mover 52, the transmission 56, and/or the transfer case 58. According to an exemplary embodiment, the PTO 90 is configured to facilitate driving an attached implement and/or a trailed implement of the vehicle 10. In some embodiments, the driveline 50 includes a PTO clutch positioned to selectively decouple the driveline 50 from the attached implement and/or the trailed implement of the vehicle 10 (e.g., so that the attached implement and/or the trailed implement is only operated when desired, etc.).

According to an exemplary embodiment, the braking system 100 includes one or more brakes (e.g., disc brakes, drum brakes, in-board brakes, axle brakes, etc.) positioned to facilitate selectively braking (i) one or more components of the driveline 50 and/or (ii) one or more components of a trailed implement. In some embodiments, the one or more brakes include (i) one or more front brakes positioned to facilitate braking one or more components of the front tractive assembly 70 and (ii) one or more rear brakes positioned to facilitate braking one or more components of the rear tractive assembly 80. In some embodiments, the one or more brakes include only the one or more front brakes. In some embodiments, the one or more brakes include only the one or more rear brakes. In some embodiments, the one or more front brakes include two front brakes, one positioned to facilitate braking each of the front tractive elements 78. In some embodiments, the one or more front brakes include at least one front brake positioned to facilitate braking the front axle 76. In some embodiments, the one or more rear brakes include two rear brakes, one positioned to facilitate braking each of the rear tractive elements 88. In some embodiments, the one or more rear brakes include at least one rear brake positioned to facilitate braking the rear axle 86. Accordingly, the braking system 100 may include one or more brakes to facilitate braking the front axle 76, the front tractive elements 78, the rear axle 86, and/or the rear tractive elements 88. In some embodiments, the one or more brakes additionally include one or more trailer brakes of a trailed implement attached to the vehicle 10. The trailer brakes are positioned to facilitate selectively braking one or more axles and/or one more tractive elements (e.g., wheels, etc.) of the trailed implement.

### Continuous Tire Inflation System

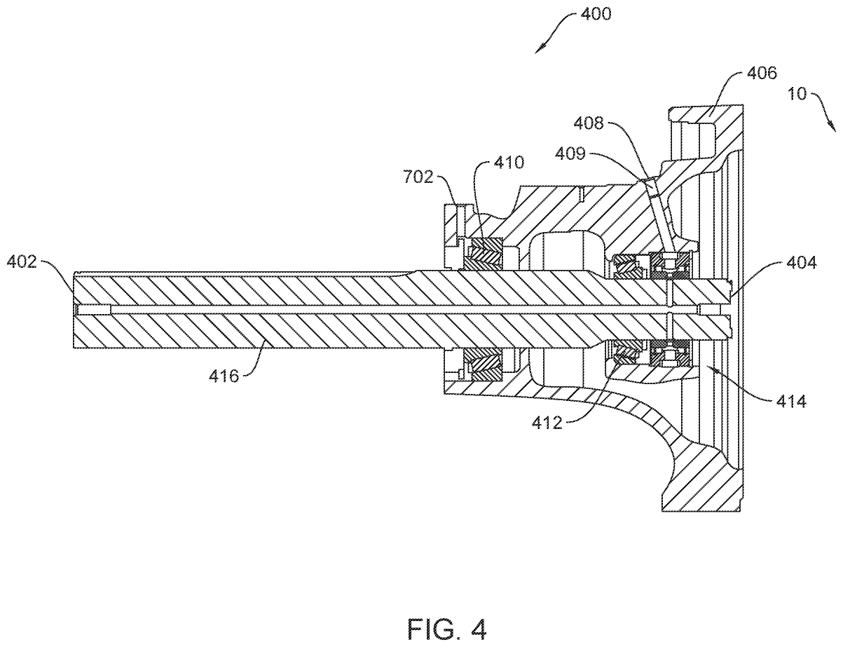

Referring now to FIG. 4, a cross-sectional view of a CTIS 400 is shown. The CTIS 400 is configured to continuously inflate an inflatable rear tire. However, in other embodiments, the CTIS 400 may be applied to a front tire. CTIS 400 includes a trumpet housing 406, an axle 416, and a CTIS subassembly 414. FIG. 4 shows a tapered roller bearing (“TRB”) 410 and TRB 412. In some embodiments, TRB 410 and TRB 412 are configured to support axle 416 and provide for the axle 416 to rotate about a longitudinal axis of the axle 416 with reduced friction. TRB 410 and 412 may be installed in the trumpet housing 406 and maintained in position therein by a friction fit. In some embodiments, a TRB cup is pressed into the trumpet housing and the TRB is then preloaded and shimmed into the TRB cup, as further described herein.

The TRB 410, 412 is a type of bearing that may be used in heavy machinery and vehicles, such as trucks, trailers, and tractors. This type of bearing is designed to handle both radial and axial loads.

Tapered roller bearings may be used in situations that result in substantial stress or vibration, as they are able to handle high levels of shock and impact. They are durable and long-lasting, which makes them a cost-effective solution for applications where maintenance and replacement costs may be high, such as in the current embodiment. In addition, tapered roller bearings are able to maintain their accuracy and stability even under heavy loads and high speeds, making them a reliable and effective solution for supporting the axle 416 of vehicle 10.

The trumpet housing 406, also known as a bell housing, is a component in the vehicle's 10 driveline 50 that serves as a protective cover for the axle 416 and CTIS components.

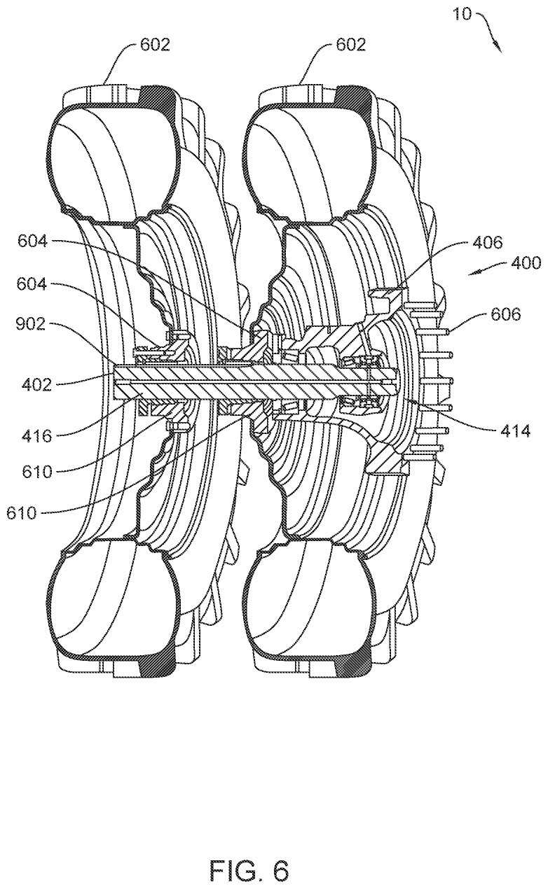

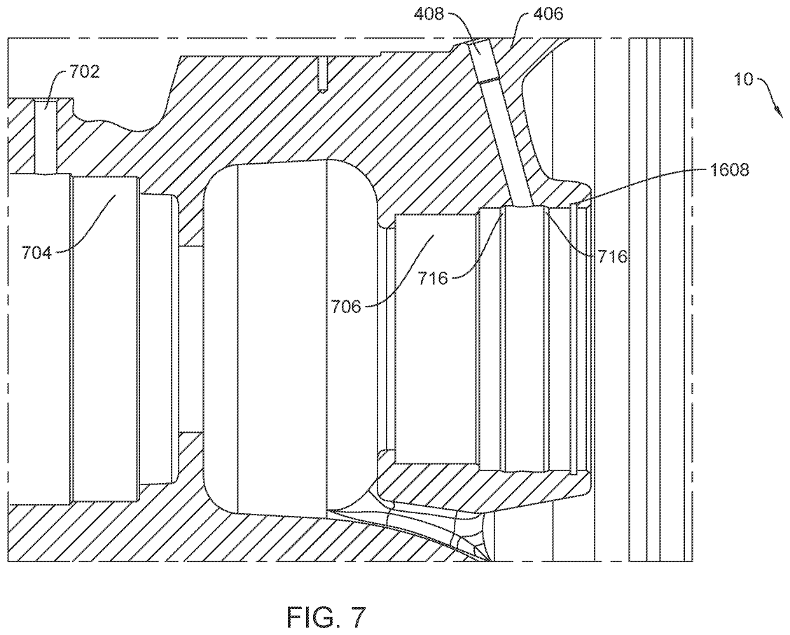

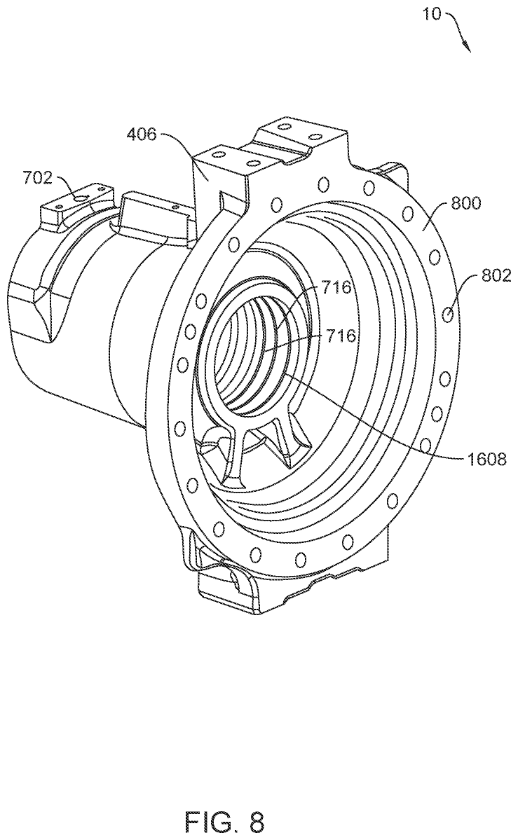

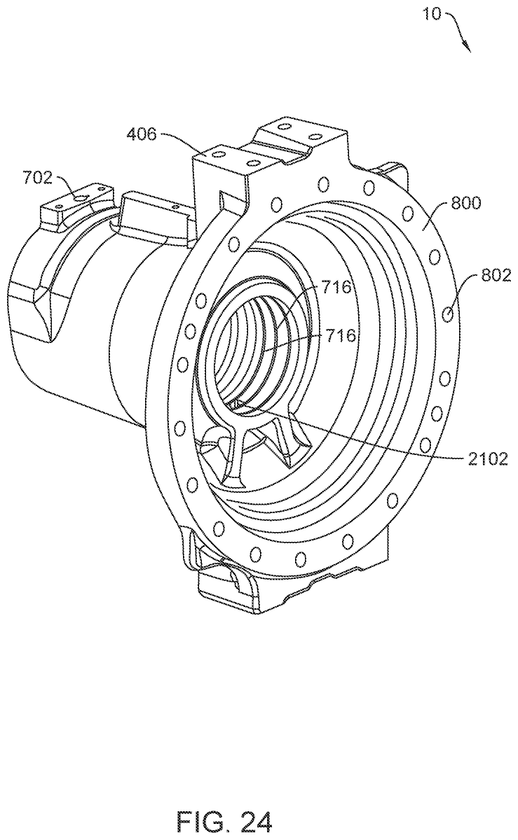

The trumpet housing 406 may be designed to provide a smooth and stable transition of power from the prime mover 52 to the axle, while also protecting the components from damage due to debris or other hazards. The trumpet housing 406 may be fixedly coupled to the chassis or frame 12 of the vehicle 10. In some embodiments, face 800 of FIG. 8 is mounted to the transfer case by bolts 606 of FIG. 6. In some embodiments, by mounting face 800 to the transfer case, a mechanical seal is created along face 800. This seal protects the inner components of the CTIS 400 from ingress of debris. In some embodiments, a gasket is disposed at mounting face 800 between the trumpet housing 406 and the transfer case. In some embodiments, the trumpet housing may be permanently affixed to the transfer case (or the chassis of vehicle 10, generally) by weldment. The trumpet housing 406 may include an air intake 408. Air intake 408 may be a channel through the case trumpet housing to allow a fluid (e.g., air) to flow from the outside of the trumpet housing to the interior of the trumpet housing. In some embodiments, the air intake 408 is removeably coupled to a hose from an onboard air compressor. In some embodiments, air intake 408 may have interior threads positioned at the exterior end 409 of the air intake 408. The interior threads may be threadedly engaged with a hose fitting extending from the onboard compressor. In some embodiments, the air intake 408 may be plugged at the exterior surface of the trumpet housing 406. In yet another embodiment, the air intake may be removeably coupled to a portable air compressor. While differing in certain respects, FIG. 24 shows a trumpet housing 406 substantially similar to the trumpet housing 406 of FIG. 8.

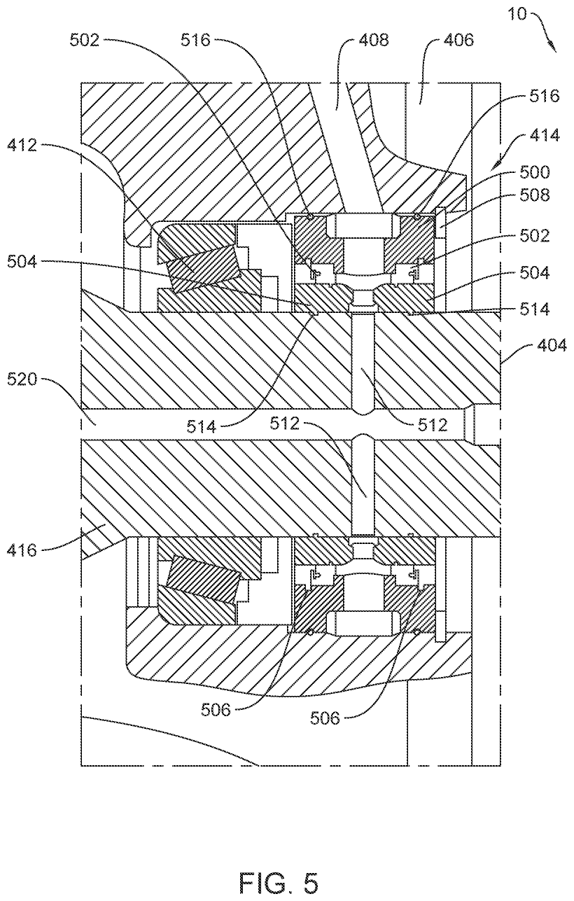

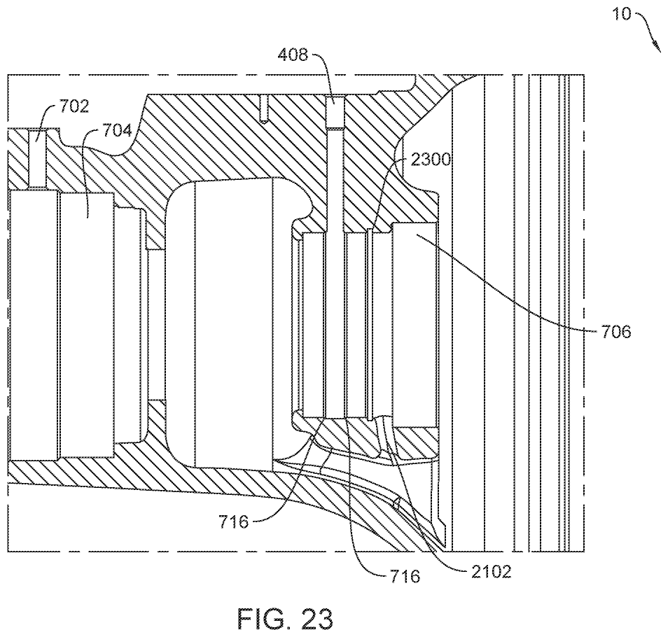

Turning to FIG. 7, a cross-sectional view of the trumpet housing is shown. The trumpet housing 406 may also include a grease fitting location 702 to which a grease zerk may be threadedly engaged. The grease zerk may be used to apply grease to the TRB 410. A TRB cup may be pressed into section 704, resulting in a friction fit. TRB 410 may then be pressed into the TRB cup, as shown in FIG. 4. Likewise, a TRB cup may be pressed into section 706, into which TRB 412 may be pressed to result in a friction fit. Trumpet housing 406 may include various grooves in its inner surface to receive various O-rings and snap rings. Examples include grooves 716, configured to receive O-rings 516 of FIG. 5. Trumpet housing 406 may also include groove 1608, which may be configured to receive snap ring 508 of FIG. 5 to maintain the CTIS subassembly 414 in place. FIG. 23 depicts an alternative embodiment of a trumpet housing. In some embodiments, as shown in FIG. 23, the TRB 410 may be placed on the interior of the CTIS subassembly 414. In this embodiment, the TRB 410 is again pressed into the TRB cup which is placed at section 706. In this embodiment, groove 2300 is used to receive the snap ring 508. Trumpet housing 406 of the embodiment of FIG. 23 also includes an oil channel 2102 to facilitate oil flow to the TRB 410, resulting in increased lubrication and cooling of TRB 410.

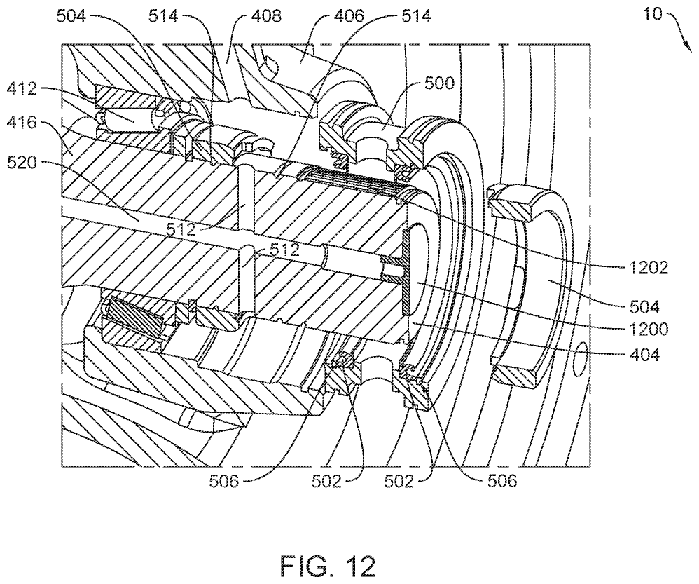

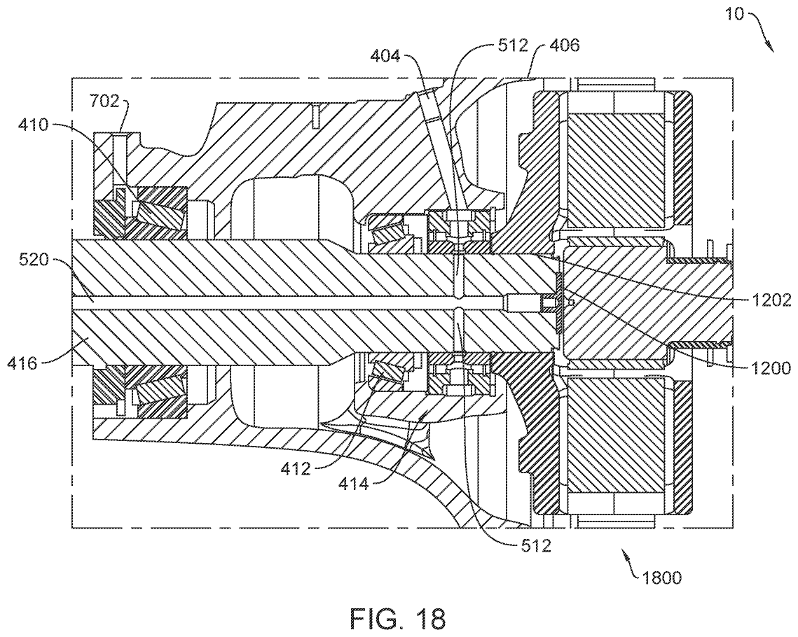

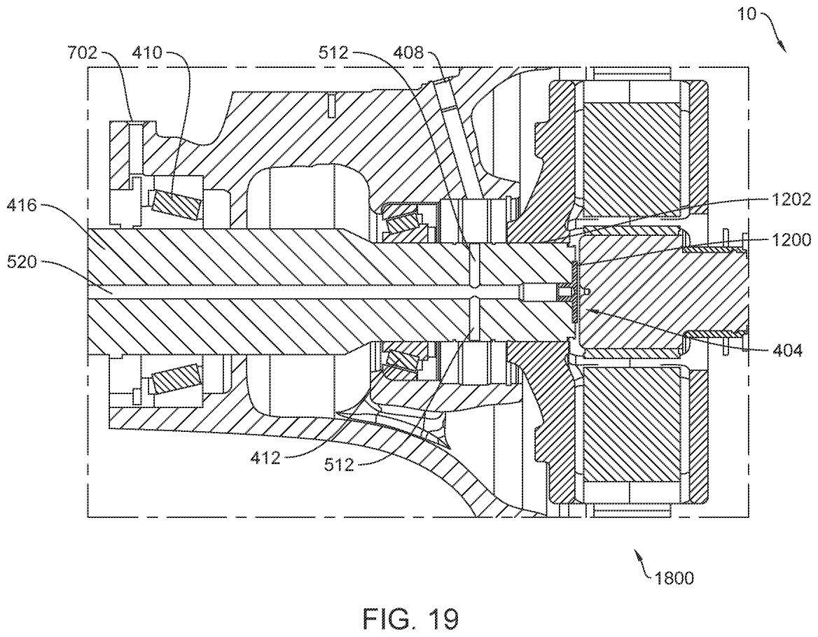

Returning to FIG. 4, the axle 416 includes an interior end 404 and an exterior end 402. The interior end 404 is placed within the trumpet housing and is protected by the trumpet housing 406 from damage. Interior end 404 has a splined profile 1202 as shown in FIG. 12. The splined profile 1202 is used to cooperatively couple with an epicyclic reduction mechanism 1800 of FIGS. 18-19.

Epicyclic reduction mechanism 1800 may be a planetary gear reduction mechanism. According to one embodiment, the epicyclic reduction member may consist of one or more planet gears rotating around a sun gear, which are in turn fixed to the splined profile 1202. The planet gears are also meshed with a ring gear, which is stationary and may be part of the gearbox casing of vehicle 10.

When the sun gear is turned by the prime mover 52, the planet gears rotate around it, and their rotation creates a reduction in speed and an increase in torque at the output shaft (e.g., the axle 416). Depending on the configuration of the gear system, the planetary gear reduction may provide multiple gear ratios and allow for smooth shifting between them.

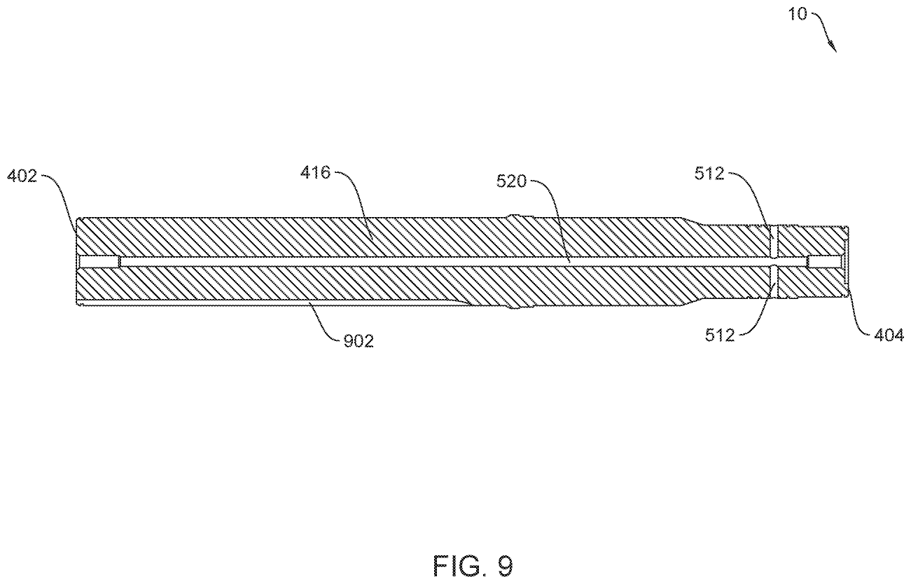

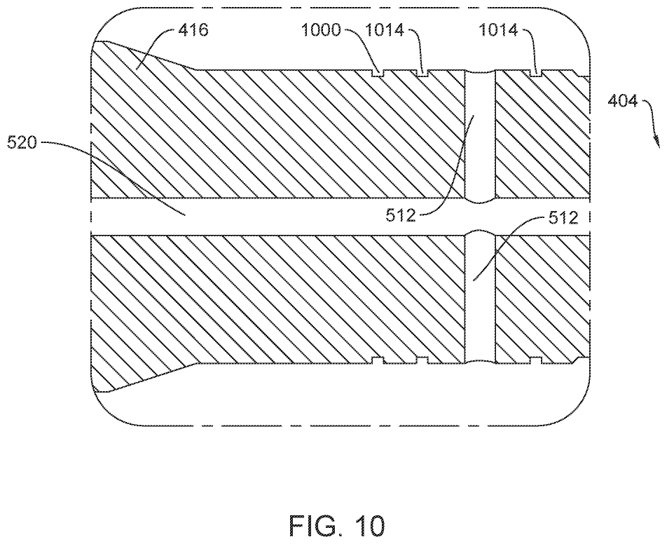

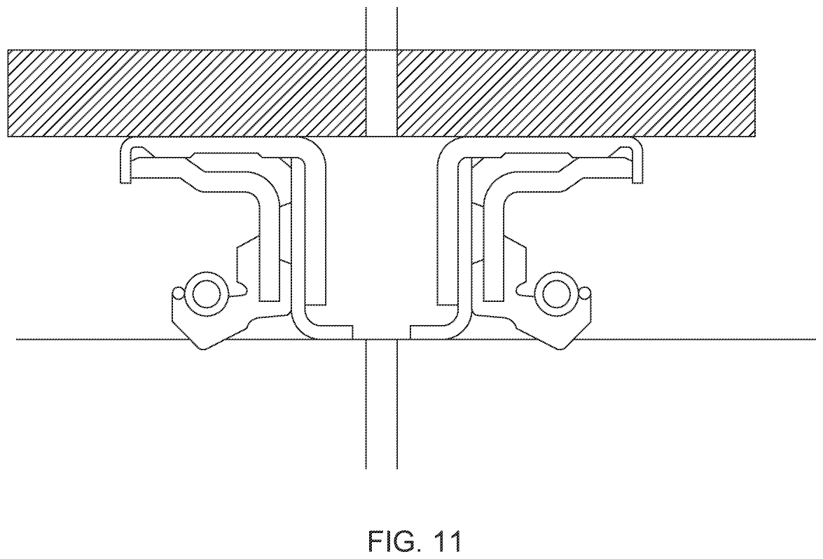

Turning back to FIG. 4, the axle 416 may include various grooves to receive various O-rings and snap rings. For example, as illustrated in FIG. 10, axle 416 may include grooves 1014 to receive O-rings 514 of FIG. 5. Likewise, axle 416 may include groove 1000 to receive a snap ring 1204 of FIG. 12. Axle 416 may also include an air delivery channel 520 of FIG. 5. Air delivery channel 520 is a hollow channel along the longitudinal axis of axle 416, as shown in FIG. 9. The air delivery channel 520 spans the length of the axle 416. However, in some embodiments, the air delivery channel 520 need not span the length of the axle 416. In some embodiments, the interior end 404 of the air delivery channel 520 is capped. For example, in FIG. 12, cap 1200 is inserted in the air delivery channel 520, thus creating an airtight seal. In some embodiments, cap 1200 is threadedly engaged with the interior end 404 of the air delivery channel 520. In other embodiments, the cap 1200 is fixedly coupled to the air delivery channel 520 through friction. In yet another embodiment, cap 1200 is permanently affixed to axle 416 to cap off the air delivery channel 520, for example, by weldment.

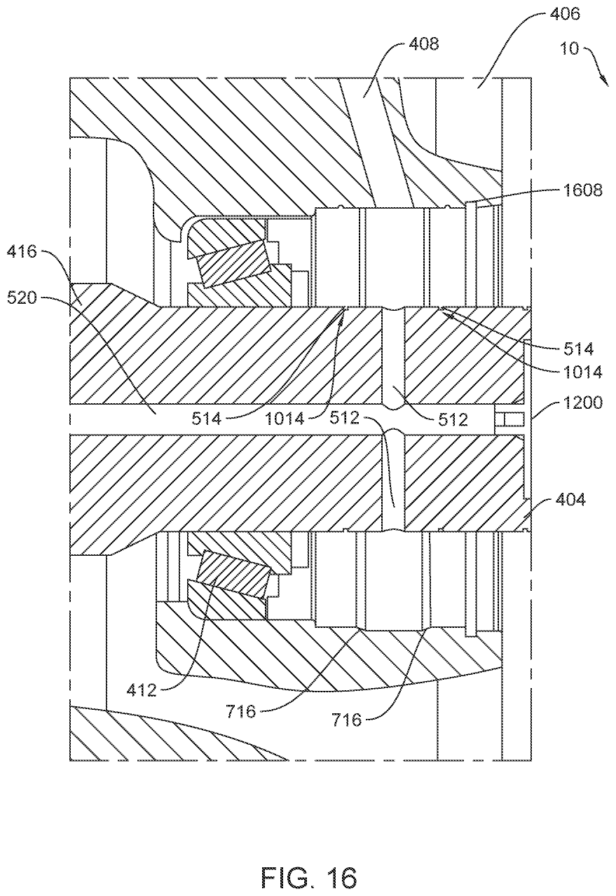

Axle 416 may also include cross bore 512. Cross bore 512 extends the diameter of the axle 416 between grooves 1014 (as shown in FIG. 16). Cross bore 512 intersects air delivery channel 520. In the various embodiments described and illustrated here in, axle 416 includes one cross bore 512 spanning the diameter of the axle 416. However, in other embodiments, the axle 416 may include more than one cross bore 512. In some embodiments, the cross bore 512 may not extend the entire diameter. In some embodiments, the cross bore 512 may extend from the exterior surface of the axle 416 to the center (e.g., the air delivery channel 520) of the axle. Cross bore 512 allows fluid to communicate from the exterior of the axle 416 to the air delivery channel 520.

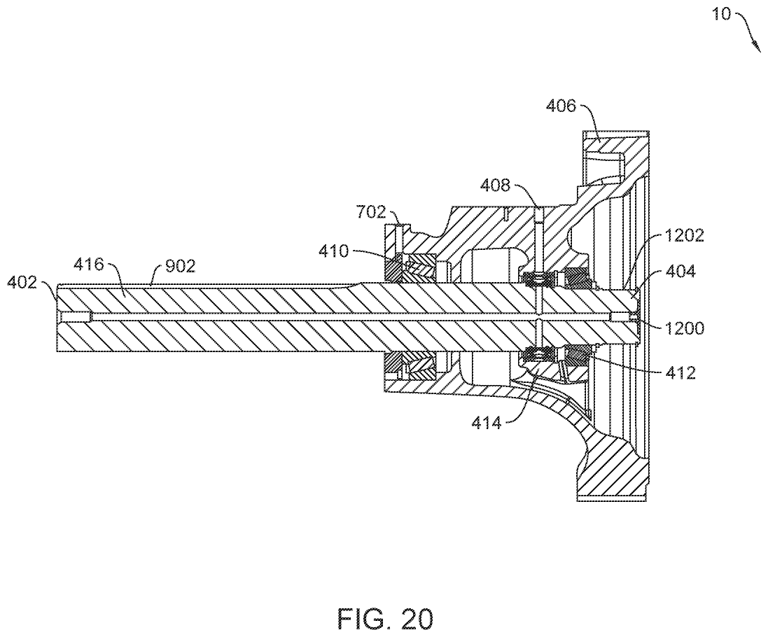

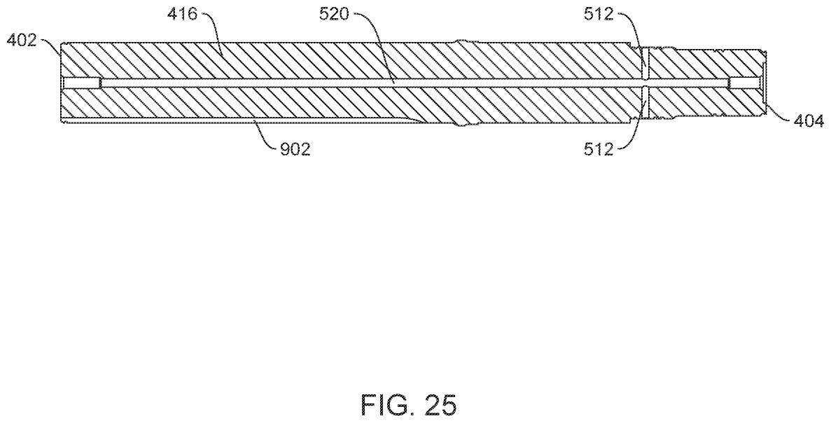

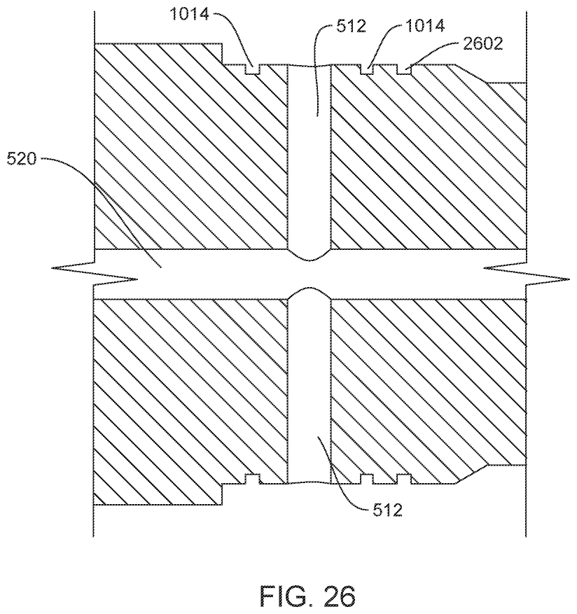

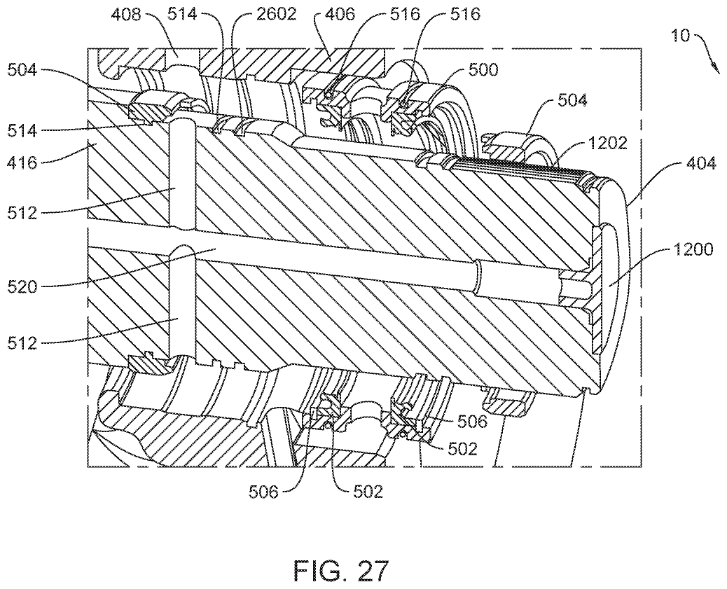

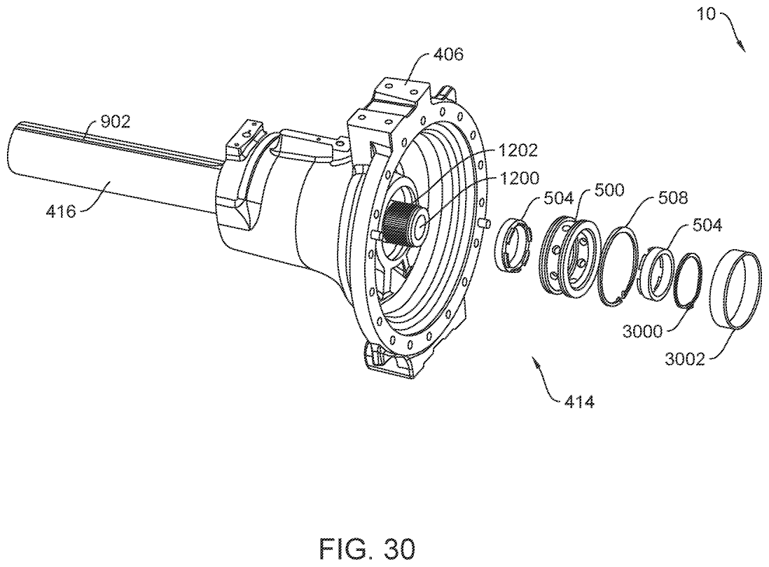

FIGS. 25-26 illustrate another embodiment of axle 416. Axle 416 of FIG. 25 includes cross bore 512, air delivery channel 520, an interior end 404, and an exterior end. As shown in FIG. 26, axle 416 also includes various grooves. For example, axle 416 of FIG. 26 includes grooves 1014 to receive O-rings 514 of FIG. 27. Axle 416 may also include groove 2602 to receive retaining ring 3000 of FIG. 30. While differing in some aspects, FIG. 20 depicts a CTIS 400 substantially similar to the CTIS 400 of FIG. 4, the differences described further herein.

Turning now to FIG. 5, the CTIS subassembly 414 is shown. The CTIS subassembly is used, in some embodiments, to connect the air intake 408 to cross bore 512 of the axle 416. Connecting these two channels poses challenges because of the rotation of axle 416 while the air intake 408 is stationary. By using O-rings 516, 514, an airtight seal is created between air intake 408 and cross bore 512. This allows air (or other pressurized fluid) to pass from air intake 408 to air delivery channel 520 without leakage. From air delivery channel 520, the air is delivered by a flexible hose into the inflatable tire, thus inflating it. Likewise, air (or other pressurized fluid) may travel in reverse through the CTIS, thus deflating the tire.

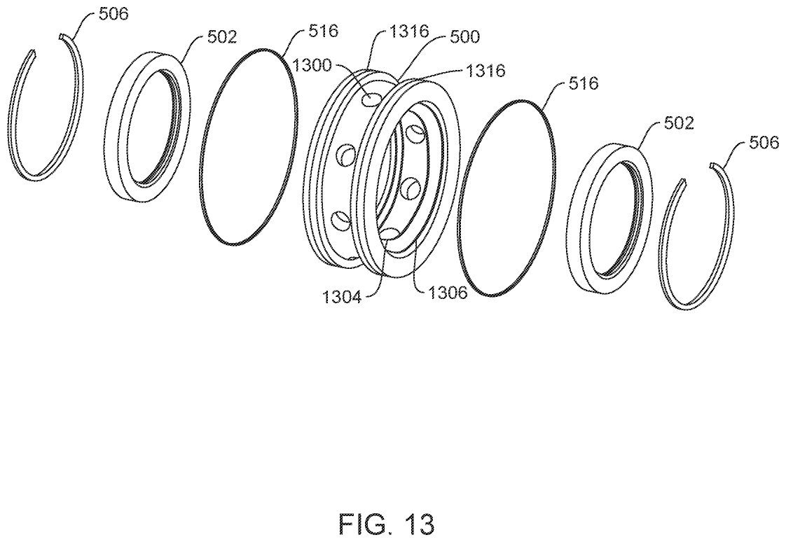

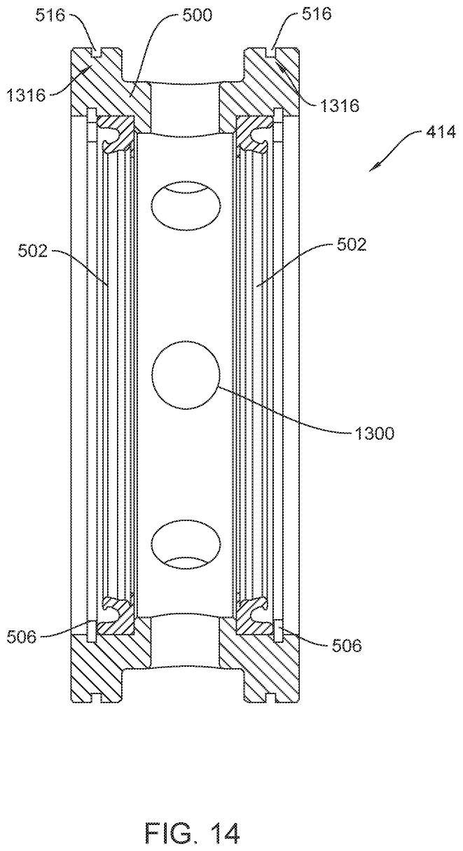

The CTIS subassembly includes a CTIS adopter 500, CTIS seals 502, snap rings 506, and O-rings 516, as shown in FIG. 13-14. CTIS adopter 500 includes grooves 1316 on an outer surface to receive O-rings 516. CTIS adopter 500 may also include grooves 1306 to receive snap rings 506. Snap rings 506 may be used to retain CTIS seals 502 once the CTIS seals 502 are assembled in the CTIS adopter 500. CTIS seals 502, in some embodiments, may be placed proximate lip 1304 on the interior surface of CTIS adopter 500. Once abutted against lip 1304, the CTIS seal 502 may be retained by snap ring 506 being placed in groove 1306. CTIS adopter also may include ports 1300, through which air may pass from the air intake 408 to cross bore 512 of the axle 416. In some embodiments, CTIS adopter may include port 1300, or many ports 1300.

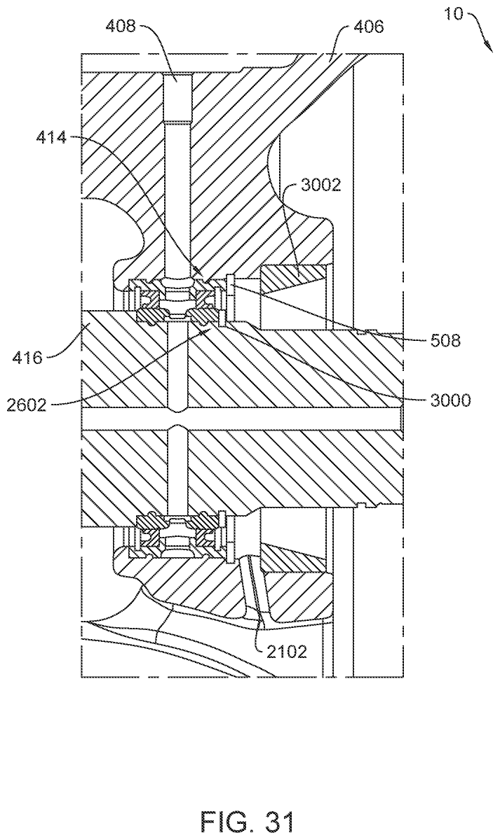

The outer surface of CTIS adopter 500 is configured to interface with the interior surface of the trumpet housing 406 and O-ring 516. However, various other methods of creating a seal between the two surfaces, including using chemical compounds, such as PTFE, may be used. By using a separate CTIS subassembly 414 to create the air seal between cross bore 512 and air intake 408, a manufacturer of vehicle 10 may sell models of vehicle 10 with or without the CTIS system. By developing an axle 416 and corresponding trumpet housing 406 to function with or without the CTIS subassembly 414, the manufacturer may sell different models without substantially changing the manufacturing process. The trumpet housing 406 of the present disclosure may be designed to accept the axle 416 with or without the CTIS subassembly 414. In some embodiments, as shown in FIG. 12, the CTIS subassembly 414 may be removed and serviced without removing TRB 412. This increases the efficiency of repairs because the critical preloading process of placing the TRB 412 will not have to be repeated after repair of the CTIS assembly, as may be necessary in the embodiment shown in FIG. 31.

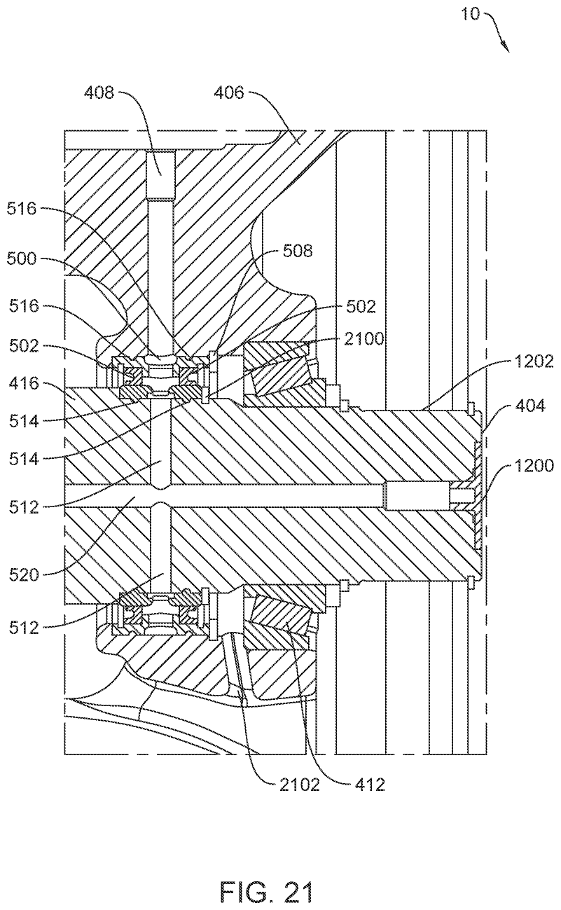

The CTIS subassembly 414 also interfaces with the sealing bush adopter 504. In some embodiments, the CTIS 400 includes two sealing bush adopters 504. Having two sealing bush adopters allows for sequential mounting of the components and allows for effective seal lip position (as shown in FIG. 11). The sequential fitment of the CTIS by using two identical sealing bush adopters 504 instead of a single, larger sealing bush adopter ensures that the required seal lip position is achieved without damage to the sealing bush adopters 504. Each sealing bush adopter 504 is placed over a corresponding O-ring 514 of FIG. 16. FIG. 5 illustrates the assembled CTIS subassembly 414 installed in the trumpet housing 406 with the sealing bush adopters 504. In another embodiment of the CTIS system installed is shown in FIG. 21. In FIG. 21, the TRB 410 is placed interior of the CTIS subassembly 414.

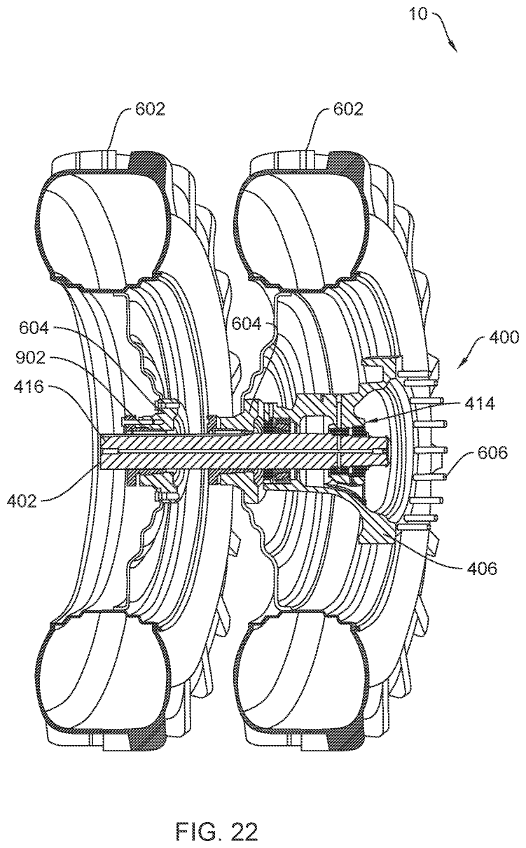

FIG. 6 illustrates the CTIS 400 when attached to inflatable tires 602. In the embodiment shown in FIG. 6, the inflatable wheels 602 are attached to the drive axle 416 by the keyway 902 of FIG. 9. The inflatable wheels 602 are attached to a wheel rim which has a hub 604 with a key 610 to interface with the keyway 902 of axle 416. The inflatable wheels 602 may be in fluid communication with the exterior end 402 of the air supply channel 520. This fluid communication may be accomplished by a flexible hose fixedly coupled to the air supply channel 520 at the exterior end 402 of the axle 416. The hose may be fixedly coupled directly to air supply channel 520, or may be fixedly coupled to a fitting (not shown) which is threadedly engaged with air supply channel 520 at the exterior end 402. FIG. 22 illustrates an alternative embodiment of the CTIS with inflatable wheels.

Turning now to FIGS. 14-19, a method of installing the CTIS 400 is shown. The first step of the CTIS installation process includes preparing the CTIS subassembly 414 by assembling the CTIS seals 502 and snap rings 506 inside the CTIS adopter 500 at grooves 1306. The O-rings 516 are then installed in grooves 1316. It should be understood that the process of preparing the CTIS subassembly may be done in any order, and the order disclosed herein is for exemplary purposes only. FIG. 14 is a cross-sectional view of the assembled CTIS subassembly 414.

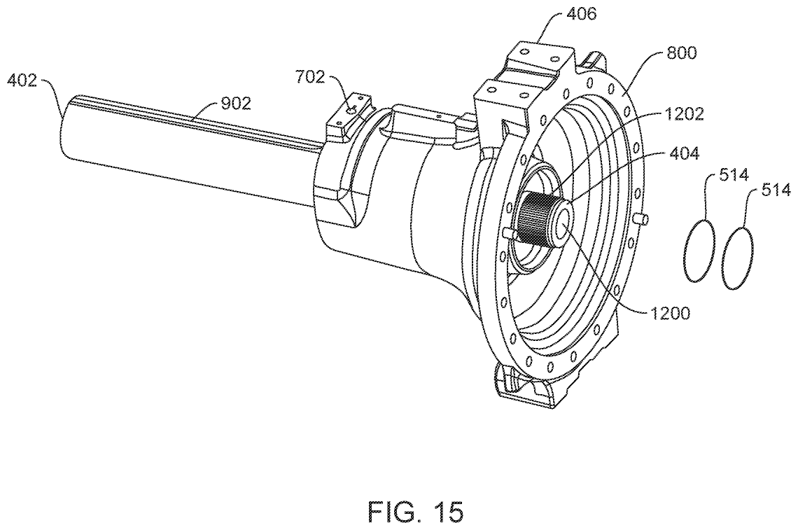

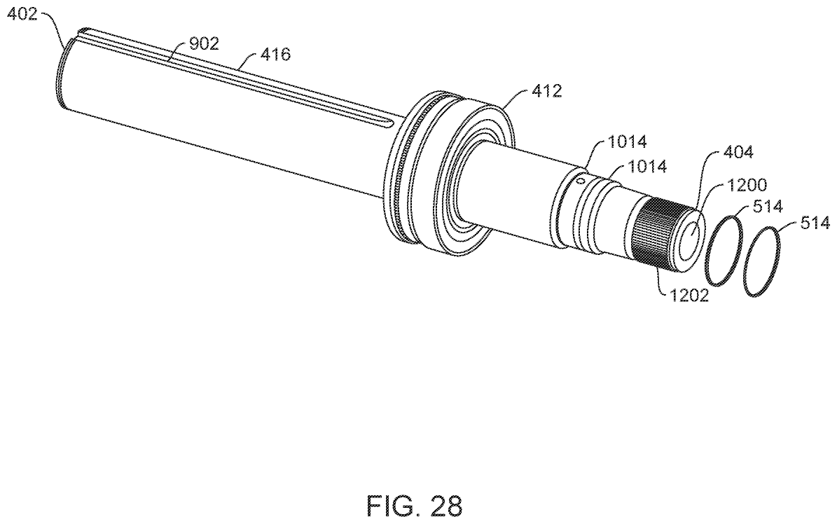

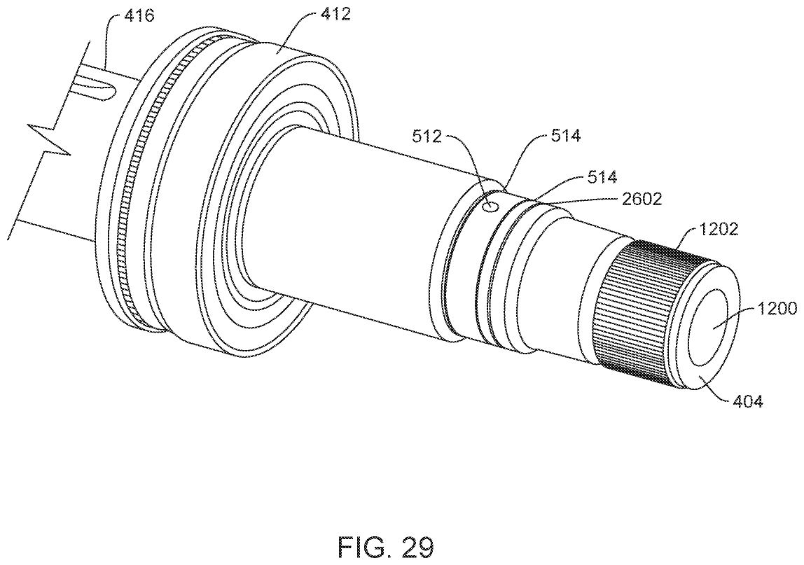

The next step includes assembling the axle shaft subassembly. In FIG. 15, the inner TRB 412 (as shown in FIG. 16) is shimmed and preloaded. In an alternative embodiment, as depicted in FIGS. 28-29, the inner TRB is not preloaded and shimmed at this point. Next, the two O-rings 514 are installed onto the shaft in grooves 1014. As shown in FIG. 16, the O-rings 514 are assembled in the grooves 1014, as shown in FIG. 16.

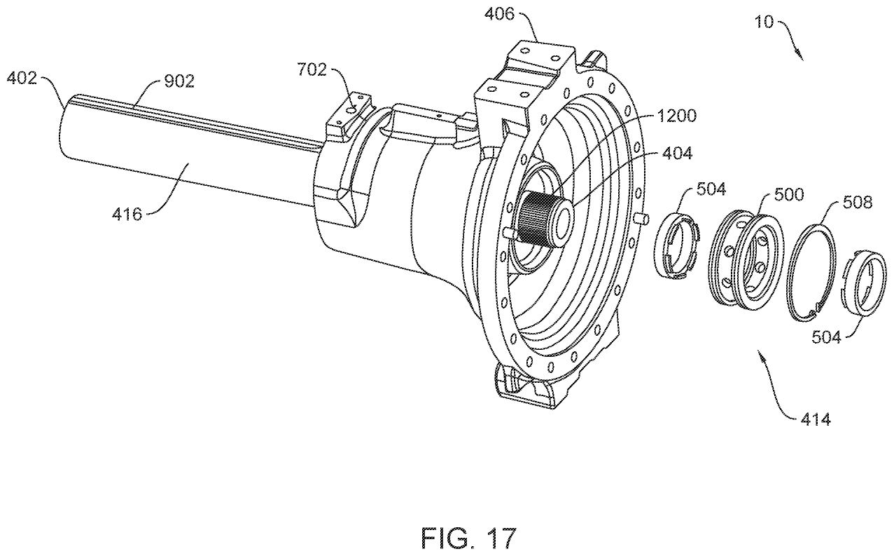

Next, as shown in FIG. 17 and FIG. 30, the sealing bush adopter 504 is assembled onto the axle 416 at the interior end 404. The first bush adopter 504 is placed over the exterior O-ring 14 of FIG. 16. The CTIS subassembly 414 is then placed over the first sealing bush adopter 504 so that the exterior CTIS seal 502 of FIG. 5 is in contact with the outer surface of the first bush adopter 504. Next, the snap ring 508 is placed in groove 1608 of FIG. 16. This retains the CTIS subassembly 414 in place. Next the second sealing bush adopter 504 is assembled onto the axle 416 over the inner O-ring 514, the outer surface of the second sealing bush adopter in contact with the inner surface of the inner CTIS seal 502.

The second (interior) sealing bush adopter 504 can be held in various ways. For example, in FIG. 18, the epicyclic reduction mechanism 1800 is assembled onto the interior end 404 over the spline profile 1202. In FIG. 18 the epicyclic reduction mechanism 1800 holds the sealing bush adopters 504 in place. In FIG. 30, a retaining ring 3000 may be used to retain the sealing bush adopters 504. Retaining ring 3000 may be assembled in groove 3100, as shown in FIG. 31. After placing the retaining ring 3000 in groove 3100 of FIG. 31, TRB cup 3002 is pressed into the trumpet housing 406. With the TRB cup 3002 pressed into the trumpet housing 406, the inner TRB 412 is preloaded and shimmed into TRB cup 3002. After preloading and shimming the inner TRB 412 into TRB cup 3002, the remaining parts 3200, 3202, 3204, and 3206 are assembled onto the axle 416 at the interior end 404.

As previously disclosed, in some embodiments, the trumpet housing 406 and axle 416 are configured to function with or without the CTIS subassembly 414. FIG. 19 shows the axle 416 and trumpet housing 406 without the CTIS subassembly 414.

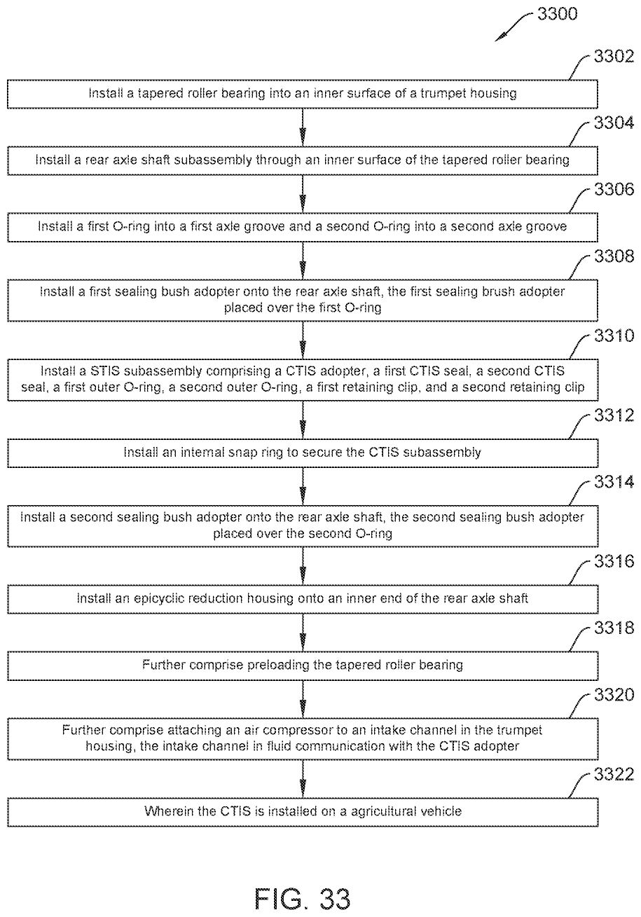

FIG. 33 is a flowchart of an example process 3300. In some implementations, one or more process steps of FIG. 33 may be performed by an apparatus.

As shown in FIG. 33, process 3300 may include installing a tapered roller bearing into an inner surface of a trumpet housing (step 3302). For example, an apparatus may install a tapered roller bearing into an inner surface of a trumpet housing, as described above. As also shown in FIG. 33, process 3300 may include installing a rear axle shaft subassembly through an inner surface of the tapered roller bearing (step 3304). For example, the apparatus may install a rear axle shaft subassembly through an inner surface of the tapered roller bearing, as described above. As further shown in FIG. 33, process 3300 may include installing a first O-ring into a first axle groove and second O-ring into a second axle groove (step 3306). For example, the apparatus may install a first O-ring into a first axle groove and second O-ring into a second axle groove, as described above. As also shown in FIG. 33, process 3300 may include installing a first sealing bush adopter onto the rear axle shaft, the first sealing bush adopter placed over the first O-ring (step 3308). For example, the apparatus may install a first sealing bush adopter onto the rear axle shaft, the first sealing bush adopter placed over the first O-ring, as described above. As further shown in FIG. 33, process 3300 may include installing a CTIS subassembly, the CTIS subassembly having a CTIS adopter, a first CTIS seal, a second CTIS seal, a first outer O-ring, a second outer O-ring, a first retaining clip, and a second retaining clip (step 3310). For example, the apparatus may install a CTIS subassembly, the CTIS subassembly having a CTIS adopter, a first CTIS seal, a second CTIS seal, a first outer O-ring, a second outer O-ring, a first retaining clip, and a second retaining clip, as described above. As also shown in FIG. 33, process 3300 may include installing an internal snap ring to secure the CTIS subassembly (step 3312). For example, the apparatus may install an internal snap ring to secure the CTIS subassembly, as described above. As further shown in FIG. 33, process 3300 may include installing a second sealing bush adopter onto the rear axle shaft, the second sealing bush adopter placed over the second O-ring (step 3314). For example, the apparatus may install a second sealing bush adopter onto the rear axle shaft, the second sealing bush adopter placed over the second O-ring, as described above. As also shown in FIG. 33, process 3300 may include installing an epicyclic reduction housing onto an inner end of the rear axle shaft (step 3316). For example, the apparatus may install an epicyclic reduction housing onto an inner end of the rear axle shaft, as described above.

Process 3300 may include additional implementations, such as any single implementation or any combination of implementations described below and/or in connection with one or more other processes described elsewhere herein. A first implementation, process 3300 may include preloading the tapered roller bearing.

A second implementation, alone or in combination with the first implementation, process 3300 may include attaching an air compressor to an intake channel in the trumpet housing, the intake channel in fluid communication with the CTIS adopter.

In a third implementation, alone or in combination with the first and second implementation, the CTIS is installed on an agricultural vehicle.

Although FIG. 33 shows example steps of process 3300, in some implementations, process 3300 may include additional steps, fewer steps, different steps, or differently arranged steps than those depicted in FIG. 33. Additionally, or alternatively, two or more of the steps of process 3300 may be performed in parallel.

It is important to note that the construction and arrangement of the vehicle 10 and the systems and components thereof (e.g., the driveline 50, the braking system 100, the control system 200, etc.) as shown in the various exemplary embodiments is illustrative only. Additionally, any element disclosed in one embodiment may be incorporated or utilized with any other embodiment disclosed herein.

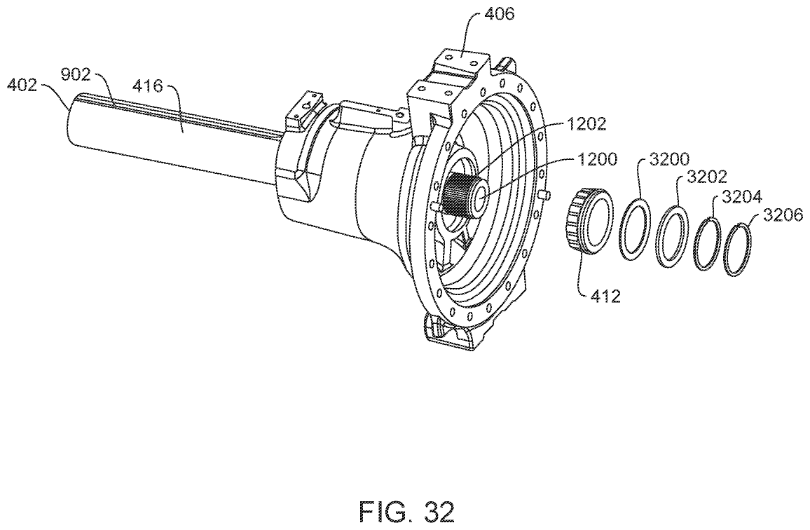

In one implementation of the present disclosure, FIGS. 4-19 illustrate one embodiment. In another implementation of the present disclosure, FIGS. 20-32 illustrate one embodiment. However, in some implementations, any component of FIGS. 1-33 may be combined with any other component of FIGS. 1-33.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

1. An agricultural vehicle comprising:
a chassis;
a trumpet housing fixedly coupled to the chassis, the trumpet housing having an intake channel from an outer surface of the trumpet housing to an inner surface of the trumpet housing;
an air compressor in fluid communication with the intake channel of the trumpet housing at the outer surface of the trumpet housing;
an axle rotatably coupled to the trumpet housing by at least one roller bearing so as to allow the axle to rotate about a longitudinal axis of the axle, wherein the axle has a bored center channel along the longitudinal axis of the axle, the axle further having a supply channel through a diameter of the axle proximate an inner end of the axle, the inner end having a splined profile to cooperatively couple to an epicyclic reduction housing;
an continuous tire inflation system (CTIS) comprising:
a first outer O-ring;
a second outer O-ring;
a CTIS adopter in fluid communication to the trumpet housing, wherein the first outer O-ring and the second outer O-ring cause a seal between an outer surface of the CTIS adopter and the inner surface of the trumpet housing;
a first sealing bush adopter, wherein an inner surface of the first sealing bush adopter interfaces with an outer surface of the axle;
a second sealing bush adopter, wherein an inner surface of the second sealing bush adopter interfaces with the outer surface of the axle;
a first CTIS seal configured to interface between an inner surface of the CTIS adopter and an outer surface of the first sealing bush adopter;
a second CTIS seal configured to interface between the inner surface of the CTIS adopter and an outer surface of the second sealing bush adopter;
a first retaining ring configured to retain the first CTIS seal in physical contact with the CTIS adopter;
a second retaining ring configured to retain the second CTIS seal in physical contact with the CTIS adopter; and
at least one inflatable tire fixedly coupled to the axle and in fluid communication with the bored center channel of the axle.

2. The agricultural vehicle of claim 1, wherein the agricultural vehicle is a tractor.

3. The agricultural vehicle of claim 1, wherein the at least on inflatable tire is in fluid communication to the bored center channel of the axle by a flexible pipe.

4. The agricultural vehicle of claim 1, wherein the bored center channel of the axle is closed at the inner end.

5. The agricultural vehicle of claim 1, wherein the axle is a rear-drive axle of the agricultural vehicle.

6. The agricultural vehicle of claim 1, wherein the CTIS is in fluid communication with the intake channel at the inner surface of the trumpet housing, wherein the CTIS is in further fluid communication with the supply channel of the axle.

7. The agricultural vehicle of claim 1, wherein the first sealing bush adopter and the second sealing bush adopter interlock on either side of the supply channel through the diameter of the axle to seal a fluid passage between the intake channel and the supply channel.

8. The agricultural vehicle of claim 1, wherein the agricultural vehicle is configured to function both with and without the CTIS.

9. A continuous tire inflation system (CTIS) comprising:
a first outer O-ring;
a second outer O-ring;
a CTIS adopter in fluid communication with a trumpet housing, wherein the first outer O-ring and the second outer O-ring cause a seal between an outer surface of the CTIS adopter and an inner surface of the trumpet housing;
a first sealing bush adopter, wherein an inner surface of the first sealing bush adopter interfaces with an outer surface of an axle;
a second sealing bush adopter, wherein an inner surface of the second sealing bush adopter interfaces with the outer surface of the axle;
a first CTIS seal configured to interface between an inner surface of the CTIS adopter and an outer surface of the first sealing bush adopter;
a second CTIS seal configured to interface between the inner surface of the CTIS adopter and an outer surface of the second sealing bush adopter;
a first retaining ring configured to retain the first CTIS seal in physical contact with the CTIS adopter; and
a second retaining ring configured to retain the second CTIS seal in physical contact with the CTIS adopter.

10. The CTIS of claim 9, wherein the first sealing bush adopter and the second sealing bush adopter interlock on either side of a supply channel through a diameter of the axle to seal a fluid passage between an air intake of the trumpet housing and the supply channel.

11. The CTIS of claim 9, wherein the CTIS is configured to seal a path of fluid between the trumpet housing and an inflatable tire.

12. The CTIS of claim 9, wherein the CTIS is configured to allow fluid to flow into an inflatable tire and out of the inflatable tire.

13. The CTIS of claim 9, wherein the CTIS adopter having a first O-ring groove to receive the first outer O-ring, the CTIS adopter further having a second O-ring groove to receive the second outer O-ring.

14. The CTIS of claim 9, wherein the CTIS is installed on an agricultural vehicle.

15. The CTIS of claim 9, wherein the CTIS is an aftermarket add-on.

16. The CTIS of claim 9, wherein the CTIS is installed internally on the trumpet housing.

17. A method of installing a continuous tire inflation system (CTIS) comprising:
Installing a tapered roller bearing into an inner surface of a trumpet housing;
installing a rear axle shaft subassembly through an inner surface of the tapered roller bearing;
installing a first O-ring into a first axle groove and second O-ring into a second axle groove;
installing a first sealing bush adopter onto the rear axle shaft, the first sealing bush adopter placed over the first O-ring;
installing a CTIS subassembly, the CTIS subassembly comprising a CTIS adopter, a first CTIS seal, a second CTIS seal, a first outer O-ring, a second outer O-ring, a first retaining clip, and a second retaining clip;
installing an internal snap ring to secure the CTIS subassembly;
installing a second sealing bush adopter onto the rear axle shaft, the second sealing bush adopter placed over the second O-ring; and
installing an epicyclic reduction housing onto an inner end of the rear axle shaft.

18. The CTIS of claim 17, further comprising preloading the tapered roller bearing.

19. The CTIS of claim 17, further comprising attaching an air compressor to an intake channel in the trumpet housing, the intake channel in fluid communication with the CTIS adopter.

20. The CTIS of claim 17, wherein the CTIS is installed on an agricultural vehicle.
